(19) United States
(12) Patent Application Publication
(10) Pub. No.: US 2013/0333090 A1
(43) Pub. Date: Dec. 19, 2013

(54) TOWEL

(71) Applicant: Ennio Bruno, Novvistown, PA (US)

(72) Inventor: Ennio Bruno, Novvistown, PA (US)

(21) Appl. No.: 13/525,280

(22) Filed: Jun. 16, 2012

(51) Int. Cl. A41D 13/04; H05B 1/00

(52) U.S. Cl. 2/50; 219/211

(57) ABSTRACT

A towel that can be converted into a hood is disclosed. The towel can be used as a shoulder cape and as a hood. When being used as a shoulder cape the towel can have a pouch to hold long hair when wet. The towel can also include accessories such as shoulder warmers.

Embodiments relate generally to towels and more particularly to a salon towel and a convertible salon towel.

### BACKGROUND

Salons, barber shops and other hair styling establishments can often use a copious amount of towels during a day. Towels can be used to dry wet hair and to drape over the shoulders of a patron to prevent water and/or trimmed hair from falling on the patron's clothing. If a towel falls off the patron to the floor, a new towel must be retrieved and the towel that landed on the floor is placed into a bin or other holding apparatus to await washing.

Embodiments were conceived in light of the above-mentioned problems or limitations, among other things.

### SUMMARY

An embodiment can include a towel. The towel can have a main body having a front edge, a back edge, a first longitudinal edge, a second longitudinal edge, an outer surface and an inner surface. The towel can also include a first front fastener group disposed adjacent to a corner formed by the front edge and the first longitudinal edge, the first fastener group disposed on the outer surface. The towel can further include a second front fastener group disposed adjacent to a corner formed by the front edge and the second longitudinal edge, the second front fastener group disposed on the inner surface and configured to mate with the first front fastener group.

The towel can include a first back fastener group disposed adjacent to a corner formed by the back edge and the first longitudinal edge, the first back fastener group disposed on the outer surface. The towel can further include a second back fastener group disposed adjacent to a corner formed by the back edge and the second longitudinal edge. The towel can include a pouch disposed on the outer surface adjacent the back edge with an opening facing the front edge.

The first and second front fastener groups and the first and second back fastener groups can each include snaps. Alternatively, the first and second front fastener groups and the first and second back fastener groups each include magnets.

The towel can also include a first front accessory fastener disposed near the first front fastener group, a second front accessory fastener disposed near the second front fastener group, a first back accessory fastener disposed near the first back fastener group, and a second back accessory fastener disposed near the second back fastener group.

The towel can further include a first heating member attached between the first front accessory fastener and the first back accessory fastener, and a second heating member attached between the second front accessory fastener and the second back accessory fastener. An embodiment can also include a drawstring member attached between the first back accessory fastener and the second back accessory fastener.

Another embodiment can include a towel with a main body having a front edge, a back edge, a first longitudinal edge, a second longitudinal edge, an outer surface and an inner surface. The towel can include a first front fastener group disposed adjacent to a corner formed by the front edge and the first longitudinal edge, the first fastener group disposed on the outer surface. The towel can also include a second front fastener group disposed adjacent to a corner formed by the front edge and the second longitudinal edge, where the second front fastener group is disposed on the inner surface and configured to mate with the first front fastener group.

The towel can include a first back fastener group disposed adjacent to a corner formed by the back edge and the first longitudinal edge, the first back fastener group disposed on the outer surface, and a second back fastener group disposed adjacent to a corner formed by the back edge and the second longitudinal edge. The towel can also include a pouch disposed on the outer surface adjacent the back edge with an opening facing the front edge.

The towel can further include a first front accessory fastener disposed near the first front fastener group and a second front accessory fastener disposed near the second front fastener group. The towel can include a first back accessory fastener disposed near the first back fastener group, and a second back accessory fastener disposed near the second back fastener group.

The first and second front fastener groups and the first and second back fastener groups can each include snaps and/or magnets. The towel can also include a first heating member attached between the first front accessory fastener and the first back accessory fastener, and a second heating member attached between the second front accessory fastener and the second back accessory fastener. The towel can further include a drawstring member attached between the first back accessory fastener and the second back accessory fastener.

Yet another embodiment can include a towel with a main body having a front edge, a back edge, a first longitudinal edge, a second longitudinal edge, an outer surface and an inner surface. The towel can include a first front fastener group disposed adjacent to a corner formed by the front edge and the first longitudinal edge, the first fastener group disposed on the outer surface, and a second front fastener group disposed adjacent to a corner formed by the front edge and the second longitudinal edge, the second front fastener group disposed on the inner surface and configured to mate with the first front fastener group.

The towel can also include a pouch disposed on the outer surface adjacent the back edge with an opening facing the front edge. The towel can include a first back fastener group disposed adjacent to a corner formed by the back edge and the first longitudinal edge, the first back fastener group disposed on the outer surface, and a second back fastener group disposed adjacent to a corner formed by the back edge and the second longitudinal edge.

The towel can include a first front accessory fastener disposed near the first front fastener group, and a second front accessory fastener disposed near the second front fastener group. The towel can also include a first back accessory fastener disposed near the first back fastener group, and a second back accessory fastener disposed near the second back fastener group.

The first and second front fastener groups and the first and second back fastener groups can each include snaps and/or magnets. In any embodiment described herein, the towel can be made of terrycloth.

### BRIEF DESCRIPTION OF THE DRAWINGS

FIG. 1 is a top elevation view of an example towel in accordance with at least one embodiment.

FIG. 2 is a top elevation view of an example convertible towel in accordance with at least one embodiment.

FIG. 3 is a diagram of an example towel draped over the shoulders in accordance with at least one embodiment.

FIG. 4 is rear elevation view showing a towel pouch in accordance with at least one embodiment.

FIG. 5 is a front view of an example convertible towel with side edges being lifted in preparation for conversion from towel to hood in accordance with at least one embodiment.

FIG. 6 is an example convertible towel having been converted to a hood in accordance with at least one embodiment.

FIG. 7 is a rear view of a convertible towel having been converted to use as a hood in accordance with at least one embodiment.

FIG. 8 is a top elevation view of an example towel with shoulder warming accessories attached in accordance with at least one embodiment.

FIG. 9 is a rear view of a towel with a drawstring accessory in accordance with at least one embodiment.

### DETAILED DESCRIPTION

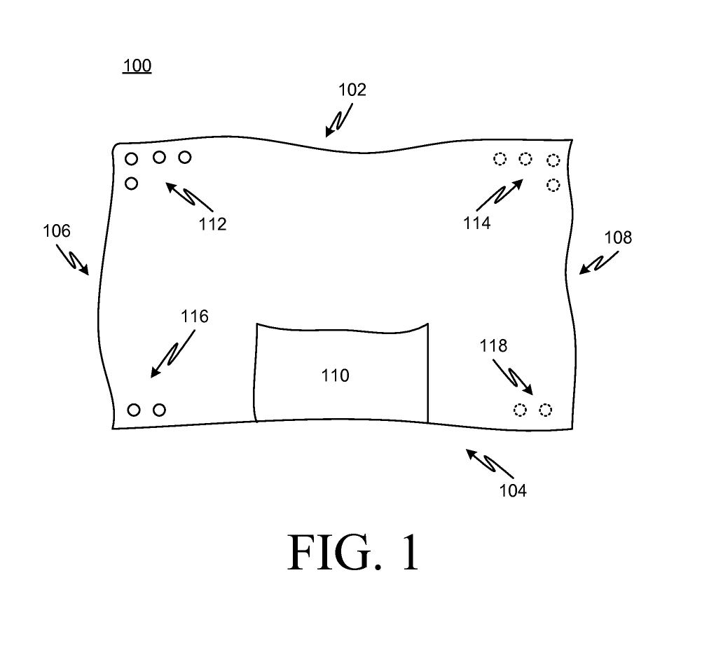

FIG. 1 shows an example towel 100 having a front edge 102, a back edge 104, a first longitudinal edge 106, a second longitudinal edge 108, a pouch 110, a first front fastener group 112, a second front fastener group 114. The towel 100 can also include optional first back fastener group 116 and second back fastener group 118.

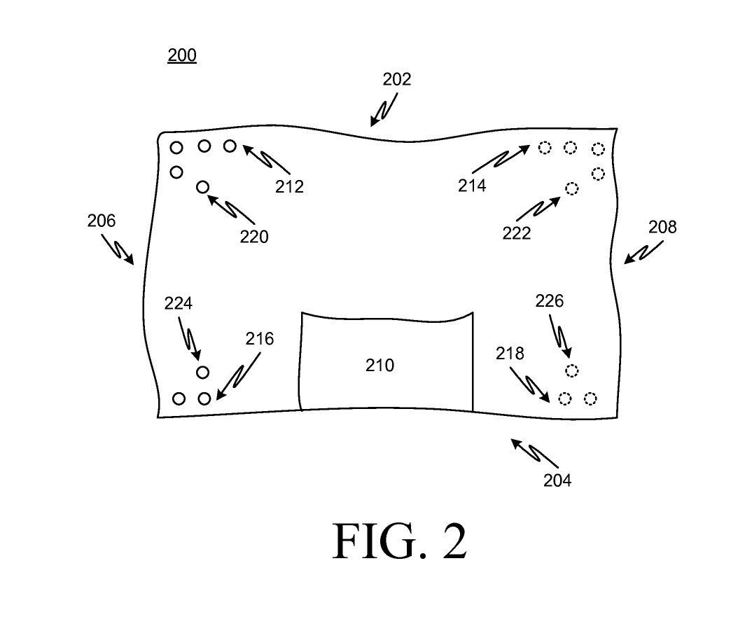

FIG. 2 shows an example towel 200 having a front edge 202, a back edge 204, a first longitudinal edge 206, a second longitudinal edge 208, a pouch 210, a first front fastener group 212, a second front fastener group 214, a first back fastener group 216 and a second back fastener group 218. The towel 200 can also include a first front accessory fastener 220, a second front accessory fastener 222, a first back accessory fastener 224 and a second back accessory fastener 226.

The fasteners of towels 100 or 200 can be snaps, hook and loop (e.g., Velcro), magnets, or the like. The towel can be made of cotton (e.g., terry cloth), silk, or any suitable natural or synthetic fiber. Also, because the towels described herein (e.g., 100 and 200) do not have any special shape or protrusions, the towels can readily be used as standard towels.

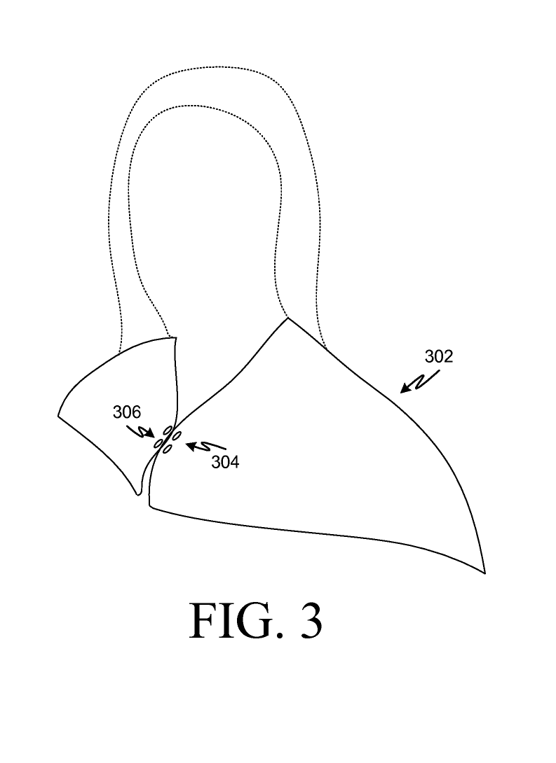

As shown in FIG. 3, a towel 302 (e.g., similar to 100 or 200) can be draped over a patron's shoulders and fastened in the front via a first front fastener group 304 and a second front fastener group 306.

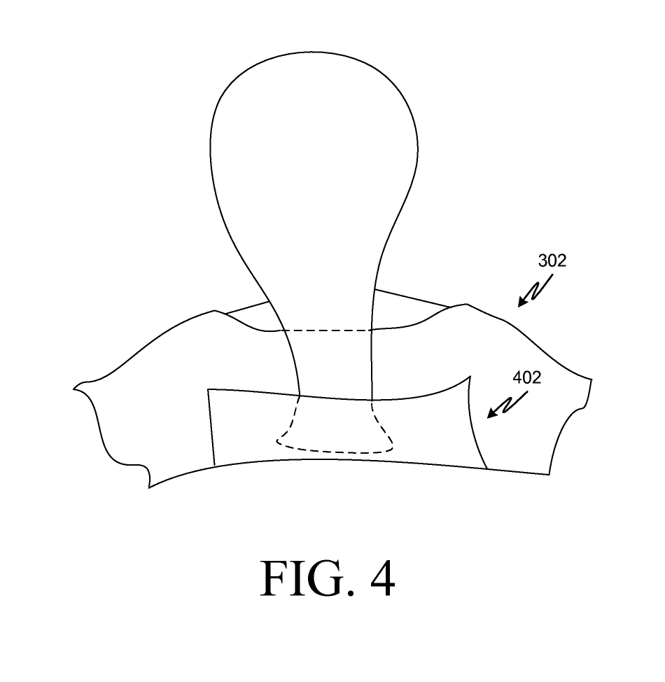

FIG. 4 shows the pouch 402 in use on a towel 302. Long hair can be gathered an placed into the pouch 402 to help dry the hair and prevent water from dripping on the floor.

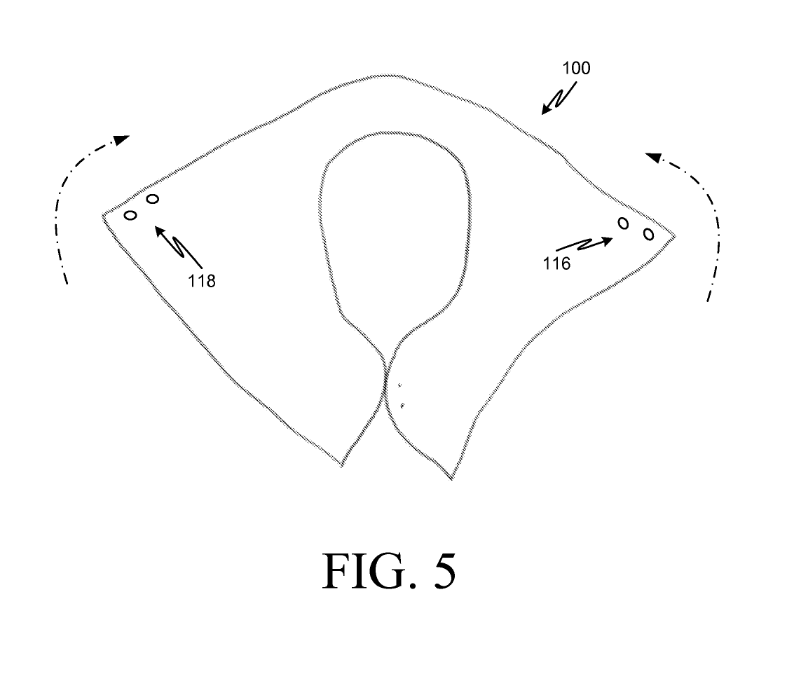

FIG. 5 shows a convertible towel 100 with longitudinal edges being raised and moved to the back to keep the towel fastened when in the converted to a hood configuration. The pouch (e.g., 110) has been raised to a person's head.

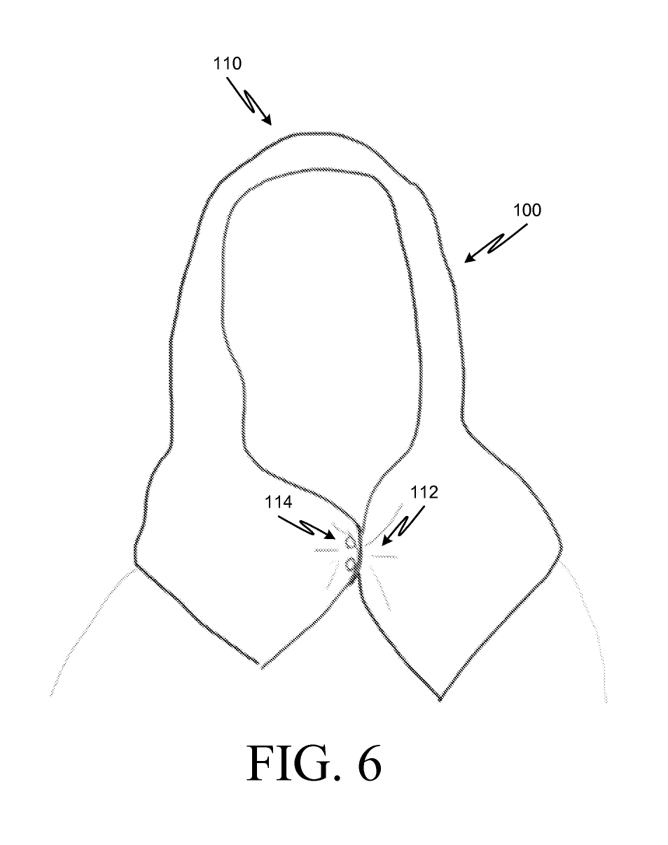

FIG. 6 shows a front view of the hood 100 fastened via front fastening groups 112 and 114. The pouch 110 has been raised to a position on top of the head.

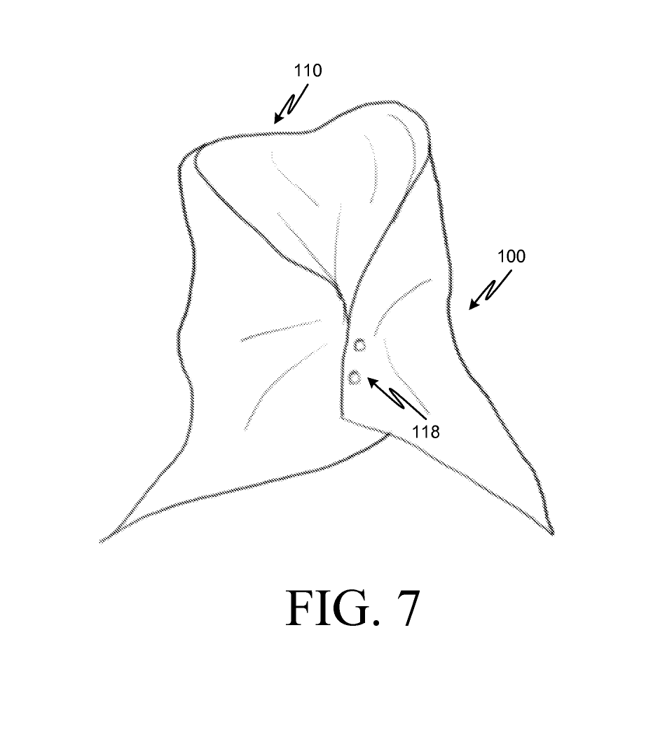

FIG. 7 shows a rear view of the towel 100 converted for use as a hood. The pouch 110 is on top and the longitudinal edges have been attached via back fasteners 118 and 116 (not shown in FIG. 7).

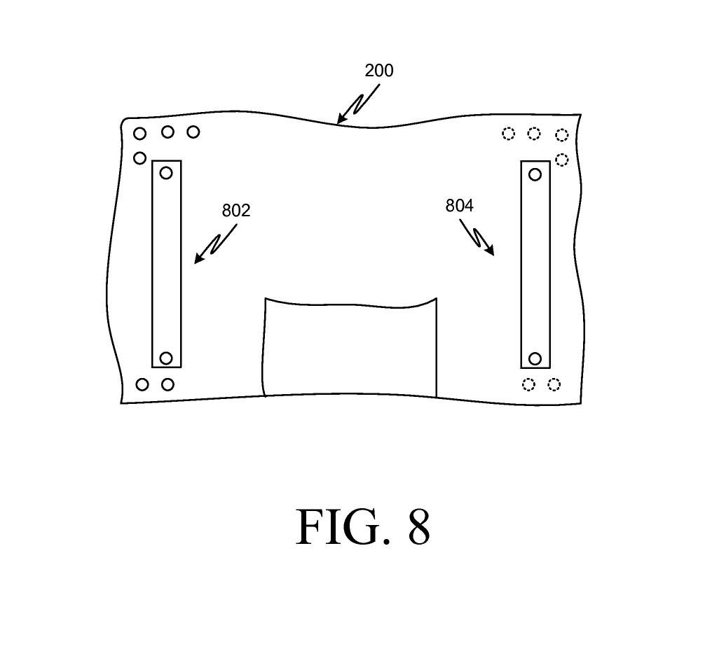

FIG. 8 shows a towel 200 with two shoulder warmers (802 and 804) attached to corresponding accessory fasteners.

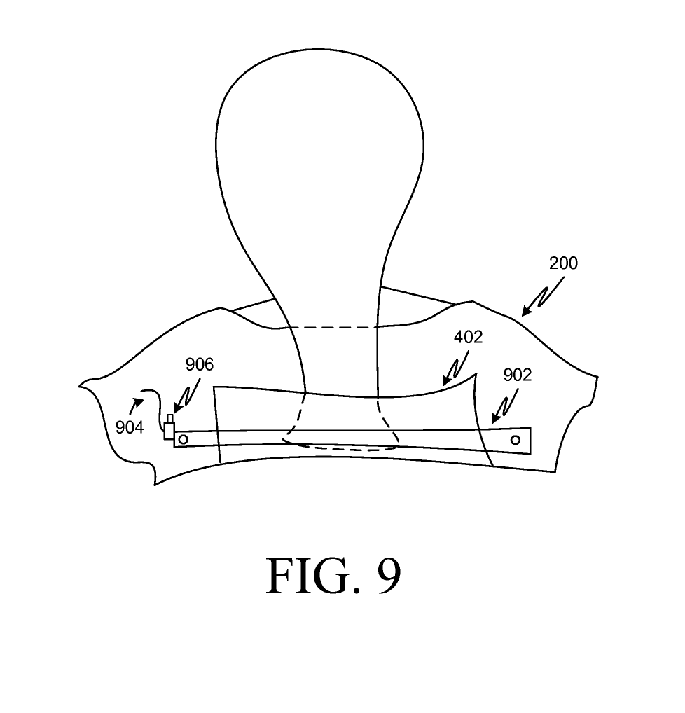

FIG. 9 shows a towel 200 with an optional drawstring accessory 902 in use. The drawstring accessory 902 can include a drawstring 904 and a stopper 906.

It is therefore apparent that there is provided in accordance with the various embodiments disclosed herein, a salon towel and a convertible towel.

While the invention has been described in conjunction of a number of embodiments, it is evident that many alternatives, modifications and variations would be or are evident to those of ordinary skill in the applicable arts. Accordingly, Applicant intends to embrace all such alternatives, modifications, equivalent and variations that are within the spirit and scope of the invention.

What is claimed is:

1. A towel comprising:
a main body having a front edge, a back edge, a first longitudinal edge, a second longitudinal edge, an outer surface and an inner surface;
a first front fastener group disposed adjacent to a corner formed by the front edge and the first longitudinal edge, the first fastener group disposed on the outer surface;
a second front fastener group disposed adjacent to a corner formed by the front edge and the second longitudinal edge, the second front fastener group disposed on the inner surface and configured to mate with the first front fastener group;
a first back fastener group disposed adjacent to a corner formed by the back edge and the first longitudinal edge, the first back fastener group disposed on the outer surface;
a second back fastener group disposed adjacent to a corner formed by the back edge and the second longitudinal edge; and
a pouch disposed on the outer surface adjacent the back edge with an opening facing the front edge.

2. The towel of claim 1, wherein the first and second front fastener groups and the first and second back fastener groups each include snaps.

3. The towel of claim 1, wherein the first and second front fastener groups and the first and second back fastener groups each include magnets.

4. The towel of claim 1, wherein the towel is made of terrycloth.

5. The towel of claim 1, further comprising:
a first front accessory fastener disposed near the first front fastener group;
a second front accessory fastener disposed near the second front fastener group;
a first back accessory fastener disposed near the first back fastener group; and
a second back accessory fastener disposed near the second back fastener group.

6. The towel of claim 5, further comprising:
a first heating member attached between the first front accessory fastener and the first back accessory fastener; and
a second heating member attached between the second front accessory fastener and the second back accessory fastener.

7. The towel of claim 5, further comprising a drawstring member attached between the first back accessory fastener and the second back accessory fastener.

8. A towel comprising:
a main body having a front edge, a back edge, a first longitudinal edge, a second longitudinal edge, an outer surface and an inner surface;
a first front fastener group disposed adjacent to a corner formed by the front edge and the first longitudinal edge, the first fastener group disposed on the outer surface;
a second front fastener group disposed adjacent to a corner formed by the front edge and the second longitudinal edge, the second front fastener group disposed on the inner surface and configured to mate with the first front fastener group;
a first back fastener group disposed adjacent to a corner formed by the back edge and the first longitudinal edge, the first back fastener group disposed on the outer surface;
a second back fastener group disposed adjacent to a corner formed by the back edge and the second longitudinal edge;
a pouch disposed on the outer surface adjacent the back edge with an opening facing the front edge;
a first front accessory fastener disposed near the first front fastener group;
a second front accessory fastener disposed near the second front fastener group;
a first back accessory fastener disposed near the first back fastener group; and
a second back accessory fastener disposed near the second back fastener group.

9. The towel of claim 8, wherein the first and second front fastener groups and the first and second back fastener groups each include snaps.

10. The towel of claim 8, wherein the first and second front fastener groups and the first and second back fastener groups each include magnets.

11. The towel of claim 8, wherein the towel is made of terrycloth.

12. The towel of claim 8, further comprising:
a first heating member attached between the first front accessory fastener and the first back accessory fastener; and
a second heating member attached between the second front accessory fastener and the second back accessory fastener.

13. The towel of claim 8, further comprising a drawstring member attached between the first back accessory fastener and the second back accessory fastener.

14. A towel comprising:
a main body having a front edge, a back edge, a first longitudinal edge, a second longitudinal edge, an outer surface and an inner surface;
a first front fastener group disposed adjacent to a corner formed by the front edge and the first longitudinal edge, the first fastener group disposed on the outer surface;
a second front fastener group disposed adjacent to a corner formed by the front edge and the second longitudinal edge, the second front fastener group disposed on the inner surface and configured to mate with the first front fastener group; and
a pouch disposed on the outer surface adjacent the back edge with an opening facing the front edge.

15. The towel of claim 14, further comprising:
a first back fastener group disposed adjacent to a corner formed by the back edge and the first longitudinal edge, the first back fastener group disposed on the outer surface; and
a second back fastener group disposed adjacent to a corner formed by the back edge and the second longitudinal edge.

16. The towel of claim 15, further comprising:
a first front accessory fastener disposed near the first front fastener group;
a second front accessory fastener disposed near the second front fastener group;
a first back accessory fastener disposed near the first back fastener group; and
a second back accessory fastener disposed near the second back fastener group.

17. The towel of claim 15, wherein the first and second front fastener groups and the first and second back fastener groups each include snaps.

18. The towel of claim 15, wherein the first and second front fastener groups and the first and second back fastener groups each include magnets.

19. The towel of claim 14, wherein the towel is made of terrycloth.
